(19) United States
(12) Patent Application Publication
(10) Pub. No.: US 2009/0230301 A1
(43) Pub. Date: Sep. 17, 2009

(54) MASS SPECTROMETRY APPARATUS AND METHOD

(75) Inventors: Osamu furuhashi, Uji (JP); Takahiro Harada, Uji (JP); Hideaki Izumi, Manchester (GB); Kiyoshi Ogawa, Kizugawa (JP)

Correspondence Address: SUGHRUE MION, PLLC, 2100 PENNSYLVANIA AVENUE, N.W., SUITE 800, WASHINGTON, DC, 20037, US

(73) Assignee: Shimadzu Corporation, Kyoto-shi (JP)

(21) Appl. No.: 12/355,462

(22) Filed: Jan. 16, 2009

(30) Foreign Application Priority Data
Mar. 17, 2008 (JP) 2008-067343

(51) Int. Cl. B01D 59/44; H01J 49/10

(52) U.S. Cl. 250/282; 250/288

(57) ABSTRACT

Disclosed is a mass spectrometry apparatus and method capable of providing enhanced analysis sensitivity in a mass spectrometric analysis for a small amount of ions. A quadrupole rod-type ion guide is employed to temporarily accumulate ions to be introduced into an ion trap, and ions are introduced into the ion guide in an amount less than a saturated ion amount in the ion guide, and accumulated in an exit end of the ion guide. As compared with an octopole rod-type ion guide, the quadrupole rod-type ion guide has a higher ion-converging capability, and therefore can confine and hold a small amount of ions around an ion optical axis, although it is inferior in ion-accumulating capability. This makes it possible to efficiently introduce the ions into the ion trap through two openings of an electric field-correcting electrode and an entrance endcap electrode, so as to perform a high-sensitive analysis.

### BACKGROUND OF THE INVENTION

1. Field of the Invention

The present invention relates to a mass spectrometry apparatus and a mass spectrometry method, and more specifically to a mass spectrometry apparatus designed to introduce ions into a three-dimensional quadrupole ion trap from an outside thereof to hold the ions therein, and then perform a mass spectrometric analysis, and a mass spectrometry method using the mass spectrometry apparatus.

2. Description of the Related Art

A three-dimensional quadrupole ion trap (hereinafter referred to simply as “ion trap”) is used for accumulating ions having a specific mass-to-charge ratio (m/z) by an action of an quadrupole electric field, and then simultaneously ejecting the accumulated ions, or fragment (product) ions formed by fragmenting the accumulated ions, to introduce them into a time-of-flight mass analyzer. In a mass spectrometry apparatus using this ion trap, it is critical for achievement of high detection sensitivity to efficiently introduce ions into the ion trap to maximize an amount of ions to be accumulated in the ion trap. From this point of view, a technique called “compressed ion injection (CII)” has been developed and put to practical use (see, for example, the following Patent Document 1 and Non-Patent Document 1).

As disclosed in the Patent Document 1, a mass spectrometry apparatus designed to perform the compressed ion injection comprises a multipole rod-type ion holding section (ion storing section) disposed between an ion source (ion supply source) and an ion trap and applied with a high-frequency electric field to have an ion confinement function, an entrance gate electrode disposed between the ion holding section and the ion source, and an exit gate electrode disposed between the ion holding section and the ion trap. The ion holding section is also applied with a DC potential having a gradient in a direction of an optical axis of an ion optical system (i.e., in a direction from an entrance to an exit thereof) in such a manner as to temporarily accumulate ions therein at a position just before the exit according to the resulting electric field. Then, the exit gate electrode is opened to simultaneously eject the ions accumulated adjacent to the exit of the ion holding section to introduce the ions into the ion trap. This makes it possible to efficiently introduce ions into the ion trap to provide enhanced analysis sensitivity.

In terms of the function of temporarily holding ions by an action of an electric field, the ion holding section can be considered as a sort of linear ion trap.

A mass spectrometry apparatus disclosed in the Non-Patent Document 1 is a liquid chromatograph/mass spectrometer (LC/MS) apparatus, wherein the above mass spectrometry apparatus employing the compressed ion injection is used as a detector for a liquid chromatograph. In the LC/MS apparatus, an ion source is designed in a type employing an atmospheric pressure ionization process, such as an electrospray ionization (ESI) process or an atmospheric pressure chemical ionization (APCI) process, and operable to receive a sample solution eluted from a column of the liquid chromatograph, and sequentially ionize sample components contained in the sample solution.

Recent years, a mass spectrometry apparatus including the LC/MS apparatus has been increasingly used in biochemical fields and medical fields. In these fields, it is often the case that only a small amount of target sample to be measured can be ensured because it originates from a biological body, or an amount of target sample to be used has to be minimized because it is extremely costly. With a view to coping with this situation, an ionization process called “nano-electrospray ionization (nano-ESI) process” has been developed which is designed to spray a small amount of sample solution at a flow rate reduced to about one-hundredth to one-thousandth a conventional flow rate (see, for example, the following Patent Document 2). Further, in other ionization processes, such as a matrix-assisted laser desorption/ionization (MALDI) process, there is a strong need for minimizing an amount of sample for use in measurement. Thus, it is tried to lower an intensity of irradiation with a laser beam, or reduce the number of repetitions (i.e., cycles) of irradiation with a laser beam to perform an integration processing for obtaining an analysis result for the same sample or sample region.

In such a measurement of a small amount of sample, an amount of ions to be generated by an ion source is inevitably reduced in itself, as compared with a measurement where a sample is supplied in a sufficient amount. Moreover, in measurements in the above fields, a component contained in a sample in an infinitesimal amount is critical in some cases. In this regard, there is also a strong need for enhancing detection sensitivity. In view of enhancing detection sensitivity under the situation where an amount of ions to be generated by an ion source is increasingly reduced, it will become more critical how to allow target ions to finally reach a detector with high efficiency.

| | |
|---|---|
| [Patent Document 1] | JP 3386048 (U.S. Pat. No. 6,700,116) |
| [Patent Document 2] | JP 2006-162256A |
| [Non-Patent Document 1] | “Compressed Ion Injection Supporting High |
| | Sensitivity, Liquid Chromatograph Mass |
| | Spectrometer LCMS-IT-TOF” [online], |
| | Shimadzu Corporation, [search: |
| | Mar. 07, 2008], Internet |
| | <URL:http ://www.an.shimadzu.co.jp/ |
| | products/lcms/it-tof2.htm> |

### SUMMARY OF THE INVENTION

In view of the above circumstances, it is an object of the present invention to provide a mass spectrometry apparatus and method capable of performing a high-sensitive mass spectrometric analysis with a less amount of sample.

In the ion trap mass spectrometry apparatus employing the compressed ion injection, there are various factors causing ion loss during transport of ions from an ion source to a detector. The inventors of this application have focused particularly on efficiency in holding ions in an ion holding section (ion holding efficiency), and efficiency in introducing ions into a three-dimensional quadrupole ion trap (ion introduction efficiency). This is based on inventors' assumption that, as compared with a three-dimensional quadrupole ion trap and a linear ion trap (ion holding section), an ion loss is likely to largely occur during ion introduction from the ion holding section to the three-dimensional quadrupole ion trap, because a volume of a space capable of holding ions, i.e., a capacity to accumulate ions, of the former ion trap is generally small than that of latter ion trap, although it varies depending on a size and temperature of each electrode and other elements, and environmental conditions, such as a degree of vacuum.

Based on the above assumption, a relationship between respective ones of the number of poles in an ion holding section, an amount of ions to be introduced into the ion holding section, and a signal intensity to be detected, has been experimentally checked. As a result, it has been proven that, in cases where an amount of sample is sufficiently large and thereby a relatively large amount of ions is introduced into an ion holding section as in a usual LC/MS analysis, an octopole rod-type ion holding section having a larger number of poles provides a higher signal intensity than that in a quadruple rod-type ion holding section, whereas, in cases where an amount of sample is small and thereby a small amount of ions is introduced into an ion holding section, the quadruple rod-type ion holding section provides a higher signal intensity than that in a case of using the octopole rod-type ion holding section.

In a multipole (quadruple or more) rod-type ion optical system, a configuration of a high-frequency electric field to be formed in a space surrounded by rod electrodes varies depending on the number of poles. Accordingly, ion optical characteristics, such as an ion-converging capability, an ion-guiding capability, an ion-receiving capability and an ion-accumulating capability, will be changed. Generally, it is described that, as the number of poles is reduced, the ion-converging capability based on cooling due to collision with neutral molecules becomes better, and, as the number of poles is increased, the ion-converging capability becomes lower, whereas each of the ion-guiding capability and the ion-accumulating capability becomes better. In cases where an absolute amount of ions to be introduced into an ion holding section is small, the ion-accumulating capability is not important because there is not any risk that ions are saturated in the ion holding section. In contrast, if the ion-converging capability is inadequate, a density of ions residing around an ion optical axis (i.e., an optical axis of the ion optical system) becomes lower, and thereby an amount of ions to be received (trapped) by an ion trap among ions ejected from the ion holding section is reduced. Therefore, it can be said that, as the optical characteristics of an ion holding section particularly in cases where an amount of ions is small, the ion-converging capability is critical rather than the ion-accumulating capability. Considering the above difference in the ion optical characteristics, it is accountable that, in cases where an amount of ions introduced into an ion holding section is small, the quadruple rod-type ion holding section provides a better result in terms of detection sensitivity. The present invention has accomplished based on the above experimental result and knowledge obtained therefrom.

Specifically, according to a first aspect of the present invention, there is provided a mass spectrometry method for use with a mass spectrometry apparatus which includes a) an ion source operable to supply ions originating from a sample, b) a three-dimensional quadrupole ion trap operable to temporarily accumulate ions introduced thereinto from an outside thereof, and then perform a mass spectrometric analysis by itself, or eject the accumulated ions therefrom to perform a mass spectrometric analysis in an outside thereof, c) a quadrupole rod-type ion holding section disposed between the ion source and the three-dimensional quadrupole ion trap, and operable to accumulate and hold ions in an exit end thereof according to a high-frequency electric field for confining ions and a DC electric field having a potential gradient in a direction from an entrance to an exit thereof, d) an entrance gate electrode disposed between the ion source and the ion holding section, and e) an exit gate electrode disposed between the ion holding section and the three-dimensional quadrupole ion trap. The mass spectrometry method comprises: introducing ions from the ion source into the ion holding section through the entrance gate electrode, in an amount less than a saturated ion amount which is a maximum capacity of the ion holding section to hold ions therein, to allow the ion holding section to hold ions therein; and opening the exit gate electrode to simultaneously introduce the ions accumulated in the exit end of the ion holding section, into the three-dimensional quadrupole ion trap, to allow the three-dimensional quadrupole ion trap to accumulate ions therein.

According to a second aspect of the present invention, there is provided a mass spectrometry apparatus intended to implement the mass spectrometry method according to the first aspect of the present invention, and designed to introduce ions into a three-dimensional quadrupole ion trap from an outside thereof to accumulate the introduced ions in the three-dimensional quadrupole ion trap, and then perform a mass spectrometric analysis. The mass spectrometry apparatus comprises a) an ion source operable to supply ions originating from a sample, b) a quadrupole rod-type ion holding section disposed between the ion source and the three-dimensional quadrupole ion trap, and operable to accumulate and hold ions in an exit end thereof according to a high-frequency electric field for confining ions and a DC electric field having a potential gradient in a direction from an entrance to an exit thereof, c) an entrance gate electrode disposed between the ion source and the ion holding section, d) an exit gate electrode disposed between the ion holding section and the three-dimensional quadrupole ion trap, and e) control means operable to control the ion source or the entrance gate electrode to introduce ions into the ion holding section in an amount less than a saturated ion amount which is a maximum capacity of the ion holding section to hold ions therein, to allow the ion holding section to hold ions therein, and then control the exit gate electrode to simultaneously introduce the ions accumulated in the exit end of the ion holding section, into the three-dimensional quadrupole ion trap.

In the mass spectrometry method and the mass spectrometry apparatus of the present invention, ions are held and accumulated in the quadrupole rod-type ion holding section having a high ion-converging capability, so that the ions reside in a narrow area around an ion optical axis in the ion holding section at a high density [within a range determined by a so-called space-charge effect due to mutual repulsion forces of ions (hereinafter referred to as “ion-ion repulsion space-charge effect”)]. Thus, when the exit gate electrode is opened, the accumulated ions are allowed to efficiently pass through an ion inlet port formed in an entrance endcap electrode of the three-dimensional quadrupole ion trap, and reliably trapped in an internal space of the ion trap having a low ion-receiving capability. As compared with an octopole rod-type ion holding section, the quadrupole rod-type ion holding section can introduce ions into the ion trap with a lower ion loss to achieve higher detection sensitivity, although it can hold a smaller amount of ions due to a smaller saturated ion amount. Thus, an amount of ions to be introduced into the ion holding section can be reduced, and therefore an amount of sample to be consumed in the ion source can be suppressed.

The saturated ion amount, i.e., a maximum capacity of the quadrupole rod-type ion holding section to hold ions therein, can be theoretically derived as an approximate value. However, in a practical sense, an experimentally obtained value has higher credibility. Further, if a certain level of standard is experimentally established, a user may empirically determine the saturated ion amount.

The ion source may be designed in a type employing a laser desorption/ionization (LDI) process typified by an MALDI process and designed to irradiate a sample or a target substance containing components of the sample (a mixture of the sample and a matrix) with a laser beam, or an atmospheric pressure ionization process, such as an electrospray ionization (ESI) process or an atmospheric pressure chemical ionization (APCI) process.

In cases where the ion source is an LDI ion source, as an intensity of the laser beam irradiation is lowered, an amount of ions to be generated becomes smaller, and therefore an amount of ions to be introduced into the ion holding section becomes smaller. Generally, an amount of ions to be generated by one cycle of the laser beam irradiation is small. Thus, the sample or the target substance is repeatedly irradiated with a laser beam plural times, and ions generated by the plurality of cycles of the laser beam irradiation are accumulated in the ion holding section. In this case, an amount of ions to be introduced into the ion holding section is reduced by reducing the number of cycles of the laser beam irradiation. Thus, the control means can control of the ion source in such a manner that an amount of ions to be held in the ion holding section becomes less than the saturated ion amount.

In cases where the ion source is an atmospheric pressure ion source, an amount of ions to be held in the ion holding section can be set to be less than the saturated ion amount by changing an ion generation condition, such as a reduction in spray amount (i.e., flow rate) of a sample solution from a nozzle, or by reducing an open time-period of the entrance gate electrode. However, in view of reducing an amount of sample, it is undesirable to change the ion generation condition in such a manner as to cause deterioration in ion generation efficiency. Thus, it is preferable to use a nano-electrospray ion source so as to minimize the spray amount.

The mass spectrometry method and the mass spectrometry apparatus of the present invention are designed to solve a problem arising from ion optical characteristics of the three-dimensional quadrupole ion trap, i.e., a low ion-receiving capability causing difficulty in introducing ions thereinto. Thus, it can be said that the effects of the present invention become prominent in harder conditions for the ion introduction. In cases where the three-dimensional quadrupole ion trap includes a pair of entrance and exit endcap electrodes, a ring electrode, and an electric field-correcting electrode disposed on the side of an outer opening of an ion inlet port formed in the entrance endcap electrode, wherein a voltage to be applied to the entrance and exit endcap electrodes has a rectangular waveform (i.e., the three-dimensional quadrupole ion trap is a digital-driven type), ions can be introduced into the ion trap only if the ions successively pass through both an opening of the electric field-correcting electrode and the ion inlet port of the entrance endcap electrode. That is, the ion introduction conditions in the digital-driven type ion trap are harder than an analog-driven type ion trap, and therefore the mass spectrometry method and the mass spectrometry apparatus of the present invention are effective for the digital-driven type ion trap.

The quadrupole rod-type ion holding section has a better ion-selecting capability than that of an octopole rod-type ion holding section. Thus, by taking advantage of this characteristic, a DC voltage and a high-frequency voltage to be applied to each of four rod electrodes of the ion holding section may be adjusted to perform mass selection of ions to be held in the mass holding section. This makes it possible to eliminate ions other than target ions to be analyzed, from ions to be accumulated in the ion holding section, to increase an amount of the target ions so as to provide more enhanced detection sensitivity.

In order to achieve the above object, according to a third aspect of the present invention, there is provided a mass spectrometry method for use with a mass spectrometry apparatus which includes a) an ion source operable to irradiate a sample or a target substance containing components of the sample with a laser beam to ionize the sample components, b) a three-dimensional quadrupole ion trap operable to temporarily accumulate ions introduced thereinto from an outside thereof, and then perform a mass spectrometric analysis by itself, or eject the accumulated ions therefrom to perform a mass spectrometric analysis in an outside thereof, c) a quadrupole rod-type ion holding section disposed between the ion source and the three-dimensional quadrupole ion trap, and operable to accumulate and hold ions in an exit end thereof according to a high-frequency electric field for confining ions and a DC electric field having a potential gradient in a direction from an entrance to an exit thereof, d) an entrance gate electrode disposed between the ion source and the ion holding section, and e) an exit gate electrode disposed between the ion holding section and the three-dimensional quadrupole ion trap. The mass spectrometry method comprises: introducing ions generated in the ion source by a plurality of cycles of the laser beam irradiation, into the ion holding section through the entrance gate electrode, to allow the ion holding section to hold ions therein; opening the exit gate electrode to simultaneously introduce the ions accumulated in the exit end of the ion holding section, into the three-dimensional quadrupole ion trap, to allow the three-dimensional quadrupole ion trap to accumulate ions therein; and performing a mass spectrometric analysis for the accumulated ions, wherein: dividing the plurality of cycles of the laser beam irradiation in the ion source during the operation of allowing the ion holding section to hold ions therein, into a plurality of groups; cyclically repeating an analysis operation of holding ions generated by the divided group of cycles of the laser beam irradiation, in the ion holding section, and introducing the ions into the three-dimensional quadrupole ion trap to perform a mass spectrometric analysis, given times equal to a total number of the divided groups; and subjecting respective results of the mass spectrometric analyses to an integration processing to obtain a mass spectrometric result for a same region on the sample or the target substance.

As mentioned above, an amount of ions to be generated by one cycle of the laser beam irradiation is generally small, and therefore the laser beam irradiation is performed plural times to obtain a mass. spectrometric result for the same region on the sample or the target substance. In this case, instead of accumulating ions generated by the plurality of cycles of the laser beam irradiation, in the ion holding section, and introducing the accumulated ions into the ion trap at once to perform a mass spectrometric analysis to obtain an analysis result, the cycles of the laser beam irradiation are divided into a plurality of groups while maintaining a total number of cycles of the laser irradiation, and the analysis operation of accumulating ions generated by a reduced number of cycles of the laser beam irradiation, in the ion holding section, and introducing the ions into the ion trap to perform a mass spectrometric analysis is cyclically repeated plural times. That is, ions originating from the sample components are divided into a plurality of groups each consisting of a small number of ions. Then, a mass spectrometric analysis for the small amount of ions is performed plural times, and respective results of the mass spectrometric analyses are subjected to an integration processing. This makes it possible to reduce an amount of ions to be held in the quadrupole rod-type ion holding section so as to improve the efficiency of introduction of ions into the ion trap and eventually provide enhanced detection sensitivity.

As above, in the mass spectrometry method according to the first aspect of the present invention and the mass spectrometry apparatus according to the second aspect of the present invention, in cases where an amount of ions to be generated in the ion source is small, the ions introduced and held in the ion holding section can be introduced into the ion trap without loss. That is, in cases where an amount of ions is small, the efficiency of introduction of the ions from the ion holding section into the ion trap can be enhanced to achieve higher detection sensitivity. This makes it possible to achieve enhanced analysis sensitivity while reducing an amount of sample to be consumed in the ion source and an amount of sample to be supplied to the ion source.

In the mass spectrometry method according to the third aspect of the present invention, even if the number of cycles of the laser beam irradiation on the same region of a sample in an LDI ion source is set in a conventional manner, enhanced analysis sensitivity can be obtained. Thus, an amount of sample to be consumed in the ion source can be reduced, for example, by lowering an intensity of the laser beam irradiation per cycle. In addition, in cases where the sample is a biological sample, a damage of the sample can be minimized by lowering an intensity of the laser beam irradiation.

### BRIEF DESCRIPTION OF THE DRAWINGS

FIG. 1 is a schematic block diagram showing an ion trap time-of-flight mass spectrometry (IT-TOFMS) apparatus according to one embodiment of the present invention.

FIG. 2 is a schematic perspective view showing a quadrupole rod-type ion guide in the IT-TOFMS apparatus according to the embodiment.

FIG. 3 is a schematic diagram showing a DC potential in a direction of an ion optical axis C of the quadrupole rod-type ion guide.

FIG. 4 is a graph showing a potential distribution to be formed in a radial direction of an inscribed circle in each of a quadrupole rod-type ion guide and an octopole rod-type ion guide, by a theoretical value.

FIGS. 5A and 5B conceptually illustrate a state of ions accumulated and held in an exit end of each of quadrupole rod-type and octopole rod-type ion guides, wherein FIG. 5A is a schematic diagram showing the state in a quadrupole rod-type ion guide, and FIG. 5B is a schematic diagram showing the state in an octopole rod-type ion guide.

FIG. 6 is a graph showing a measurement result of a relationship between an open time-period of an entrance gate electrode and a peak intensity.

FIGS. 7A to 7D are graphs showing a relationship between a pseudopotential Vqp based on a high-frequency electric field and a potential Vsc based on the ion-ion repulsion space-charge effect in a quadrupole rod-type ion guide.

FIG. 8 is a schematic block diagram showing an IT-TOFMS apparatus according to another embodiment of the present invention.

FIG. 9 is a graph showing a measurement result of a relationship between the number of cycles of laser beam irradiation per analysis and a signal intensity.

### DESCRIPTION OF THE EXEMPLARY EMBODIMENTS

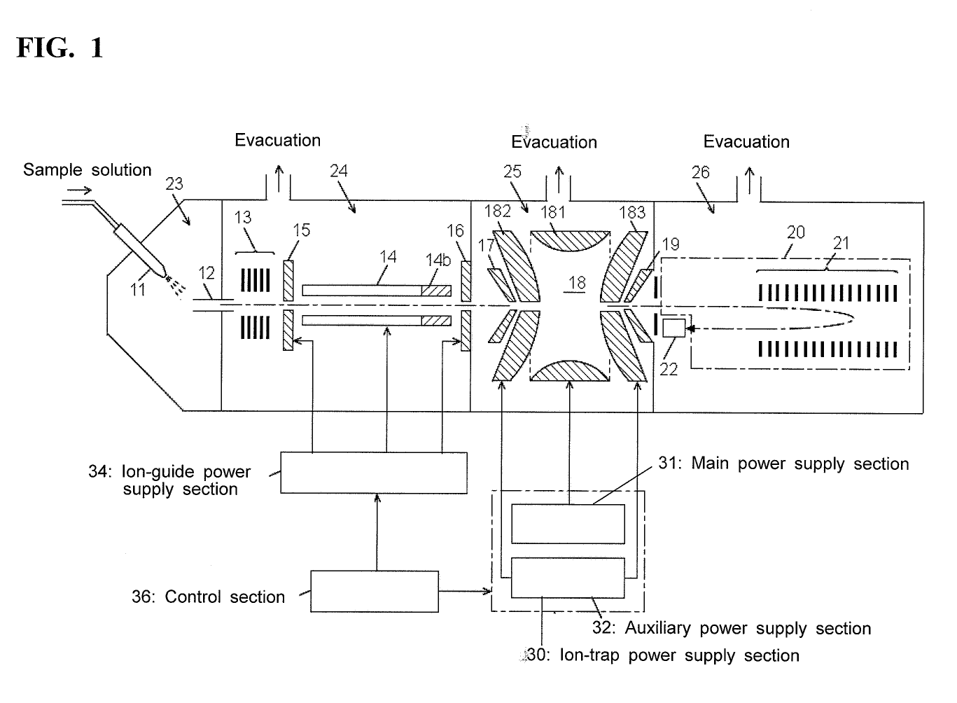

With reference to the accompanying drawings, the present invention will now be described based on an embodiment thereof. FIG. 1 is a schematic block diagram showing an ion trap time-of-flight mass spectrometry (IT-TOFMS) apparatus according to a first embodiment of the present invention. For example, a liquid chromatograph (not shown) is provided in a preceding stage to introduce a sample solution containing components of a sample being temporally separated therethrough, into the IT-TOFMS apparatus.

The IT-TOFMS apparatus comprises an ionization chamber 23 having an atmosphere at an approximately atmospheric pressure, a first intermediate vacuum chamber 24, a second intermediate vacuum chamber 25 and an analysis chamber 26, wherein the first intermediate vacuum chamber 24, the second intermediate vacuum chamber 25 and the analysis chamber 26 are designed in a multistage differential evacuation system where a degree of vacuum is gradually increased in this order. The ionization chamber 23 is provided with a nano-electrospray ionization (nano-ESI) nozzle 11 serving as an ion source. The ionization chamber 23 and the first intermediate vacuum chamber 24 are communicated with each other through a capillary tube 12 heated by a heater (not shown). The first intermediate vacuum chamber 24 houses an ion lens 13, an entrance gate electrode 15, a quadrupole rod-type ion guide 14 and an exit gate electrode 16 which are arranged in an ion propagation direction in this order. The quadrupole rod-type ion guide 14 serves as an ion holding section set forth in the appended claims.

The second intermediate vacuum chamber 25 houses: an ion trap 18 which comprises a single-piece annular-shaped ring electrode 181 having an inner surface with a shape of a hyperboloid of revolution of one sheet, and a pair of endcap electrodes 182, 183 disposed in opposed relation to each other while interposing the ring electrode 181 therebetween, to have inner surfaces with a shape of a hyperboloid of revolution of two sheets; and a pair of electric field-correcting electrodes 17, 19 disposed on the side of respective outer surfaces of the endcap electrodes 182, 183. The ion trap 18 is a so-called digital-driven type ion trap designed to be applied with a voltage having a rectangular waveform, as a driving voltage. In FIG. 1, other elements, such as a gas passage for introducing cooling gas into the ion trap 18, are omitted for simplicity of illustration.

The analysis chamber 26 as a final stage houses a time-of-flight (TOF) mass analyzer 20 having a reflectron electrode 21, and an ion detector 22. An ion-flight starting point relative to the TOF mass analyzer 20 is the ion trap 18.

The IT-TOFMS apparatus also comprises an ion-trap power supply section 30 for applying the driving voltage to the ion trap 18. The ion-trap power supply section 30 includes a main power supply section 31 for primarily applying an ion-trapping high-frequency voltage to the ion trap, and an auxiliary power supply section 32 for applying a DC voltage to the endcap electrodes 182, 183 primarily during an operation of introducing ions into the ion trap 18 and an operation of ejecting ions from the ion trap 18. Further, the IT-TOFMS apparatus comprises an ion-guide power supply section 34 for applying a superimposed voltage of a high-frequency voltage and a DC voltage to the quadrupole rod-type ion guide 14, and applying a DC voltage to each of the entrance gate electrode 15 and the exit gate electrode 16. Each of the ion-trap power supply section 30 and the ion-guide power supply section 34 is operable to apply a give voltage to each of the above devices under control of a control section 36 comprising a CPU. Although a voltage is applied to each of the remaining devices, such as the ion lens 13, its description will be omitted herein. Although not illustrated, the control section 36 is also operable to control other devices, such as a pump for determining a flow rate of a sample solution to be supplied to the nano-ESI nozzle 11.

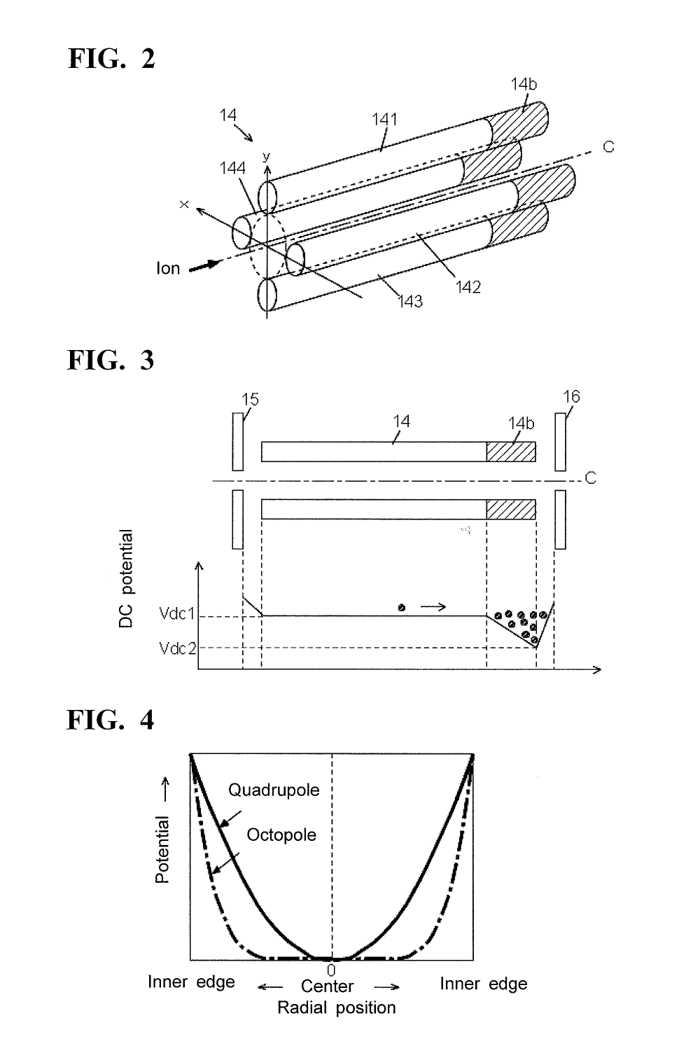

FIG. 2 is a schematic perspective view showing the quadrupole rod-type ion guide 14, and FIG. 3 is a schematic diagram showing a DC potential in a direction of an ion optical axis C of the quadrupole rod-type ion guide 14. As shown in FIG. 2, four columnar-shaped rod electrodes 141, 142, 143, 144 are disposed in parallel relation to an ion optical axis C while surrounding the ion optical axis C. Each of the rod electrodes 141 to 144 is made of an electrically conductive material, such as a metal, and an electric-resistive coating layer 14b is formed on a surface of an exit end thereof to increase a resistivity in the exit end. The ion-guide power supply section 34 is operable to apply a DC voltage Vdc1 to an entrance end of each of the rod electrodes 141 to 144, and apply a DC voltage Vdc2 (Vdc1>Vdc2) to the exit end (when ions are positive ions; the following description will be made on this assumption). As shown in FIG. 3, a portion of the rod electrode devoid of the electric-resistive coating layer 14b has approximately the same potential, and thereby a DC potential in the range of the electric-resistive coating layer 14b has a gradient inclined in a downstream direction from an entrance and to an exit of the quadrupole rod-type ion guide 14.

The four rod electrodes 141 to 144 are arranged in two pairs each disposed in opposed relation to each other across the ion optical axis C, and each of the two pairs are electrically connected to each other. One of the two pairs is applied with a high-frequency voltage of v·cos ω t, and the other pair is applied with a high-frequency voltage of v·cos (ω t+π)=−v·cos ω t having a phase lag of 180 degrees. Thus, a quadrupole electric field is formed in the ion guide 14, and ions are trapped while being vibrated, according to the electric field.

One example of an operation of the IT-TOFMS apparatus according to the first embodiment will be described below. A sample solution introduced into the nano-ESI nozzle 11 is electrically charged by a high voltage applied to a distal end of the nano-ESI nozzle 11, and sprayed into an atmosphere at an approximately atmospheric pressure in the formed of charged droplets. The charged droplets are finely broken up through collision with surrounding atmospheric gas, and further reduced in size along with vaporization of a solvent therein. During this operation, sample components contained in the droplets are released as ions. The generated ions are sucked into the capillary tube 12 according to a pressure difference between opposite ends of the capillary tube 12, and sent to the first intermediate vacuum chamber 24. In the first intermediate vacuum chamber 24, the ions are converged by the ion lens 13.

The entrance gate electrode 15 is applied with a voltage equal or less than the DC voltage Vdc1 to be applied to the entrance end of the quadrupole rod-type ion guide 14, only for a first time-period, and applied with a voltage greater than the DC voltage Vdc1 in a second time-period other than the first time-period (see FIG. 3). The first time-period corresponds to a state when the entrance gate electrode 15 is opened to allow the ions to be introduced into the quadrupole rod-type ion guide 14. In the first time-period, a voltage greater than the DC voltage Vdc2 to be applied to the exit end of the quadrupole rod-type ion guide 14 (the voltage is typically greater than the DC voltage Vdc1) is applied to the exit gate electrode 16, and thereby the exit gate electrode 16 is in its closed state.

The introduced ions are held inside the ion guide 14 by the high-frequency electric field, and moved inside the ion guide 14 by initial kinetic energy. When the ions reaches the exit end of the ion guide 14 just before the exit gate electrode 16, they are pushed back toward the entrance by repulsion of the voltage applied to the exit gate electrode 16. The entrance gate electrode 15 can be closed before the ions are returned thereto, to confine the ion within the ion guide 14. The vaporized solvent, the atmospheric gas or nebulizing gas used for the electrospray ionization flow from the ionization chamber 23 into the first intermediate vacuum chamber 24 to serve as cooling gas. When the ions are reciprocatingly moved inside the ion guide 14, they will gradually lose kinetic energy, and will be accumulated in a potential pocket formed around the exit end of the ion guide 14 by the potential gradient.

Stable gas free from a risk of causing ionization or fragmentation of target ions to be measured due to collision therewith, such as nitrogen (N₂), helium (He) or argon (Ar), may be supplied as cooling gas into the ion guide 14.

At a given timing after the ions are accumulated around the exit end of the ion guide 14 in the above manner, a voltage to be applied to the exit gate electrode 16 is lowered to open the exit gate electrode 16. Thus, the accumulated ions are simultaneously moved toward the ion trap 18. Just after the ions pass through the exit gate electrode 16, a voltage to be applied to the exit gate electrode 16 is increased to push the ions from behind so as to compress a pulse width of the ions. The ions are introduced into the ion trap 18 through an opening of the electric field-correcting electrode 17, and an ion inlet port formed in the entrance endcap electrode 182 of the ion trap 18.

During this operation, it is preferable that a timing of ejection of the ions from the ion guide 14 is adequately coordinated with a timing of voltage application or a phase of the high-frequency voltage to each of the electrodes of the ion trap 18, in order to prevent the ions from being bounded just before the ion inlet port of the ion trap 18, or from being suddenly accelerated just after they enter the ion trap 18 and vanished due to collision with the exit endcap electrode 183. For example, in cases where ions compressed in a pulse patter are introduced into the ion trap 18, the ions are introduced from the ion guide 14 into the ion trap 18 under a condition that an application of a high-frequency voltage to the ring electrode 181 is stopped, and, just after the introduction of all the ions (or a maximum number of ions), the application of the high-frequency voltage to the ring electrode 181 is started under a condition that a phase of the high-frequency voltage is set in a predetermined state. This makes it possible to efficiently introduce the ions into the ions 18 and hold the introduced ions in the ion tap 18.

Then, after the ions held in the ion trap 18 are adequately cooled, a given DC voltage is applied to the endcap electrodes 182, 183 to give initial kinetic energy to the ions, and the ions are ejected from an ion outlet port formed in the exit endcap electrode 183. The ejected ions are introduced into the TOF mass analyzer 20. In the TOF mass analyzer 20, each of the ions flies with a time lag depending on a mass thereof, while being bounded by an electric field formed by the reflectron electrode 21, and finally reaches the ion detector 22 in ascending order of mass, so that the ion detector 22 sequentially detects the ions.

The above operation may be modified as follows. Various ions held in the ion trap 18 are subjected to mass selection to leave only ions having a specific mass in the ion trap 18. Then, gas for collision-induced dissociation is introduced into the ion trap 18 to induce fragmentation of the left ions, and product ions formed by the fragmentation are subjected to a mass spectrometric analysis. Although a mass spectrometric analysis may be performed by utilizing the mass selection function of the ion trap 18 without using the TOF mass analyzer 20, the TOF mass analyzer 20 is superior in terms of mass resolution.

As described above, in the IT-TOFMS apparatus according to the first embodiment, ions introduced into the quadrupole rod-type ion guide 14 during the period where the entrance gate electrode 15 is in the open state are accumulated around the exit end of the ion guide 14. In this operation, an amount of ions to be introduced into the ion guide 14 is set to be equal to or less than a saturated ion amount which is a maximum capacity of the ion guide 14 to hold ions therein (actually, a maximum capacity of the potential pocket in the ion guide 14 to accumulate ions therein).

For example, given that ion generation conditions, such as a voltage to be applied to the nano-ESI nozzle 11 and a surrounding temperature, are the same, an amount of ions to be introduced into the ion guide 14 depends on an amount of a sample solution to be sprayed from the nano-ESI nozzle 11 (a supply flow rate of a sample solution), and an open time-period of the entrance gate electrode 15. Thus, this parameter can be appropriately set to adjust an amount of ions to be introduced into the ion guide 14. However, in cases where a liquid chromatograph is provided in a preceding stage and a column thereof is connected to the IT-TOFMS apparatus, a sample component contained in a sample solution to be introduced into the IT-TOFMS apparatus is changed over time, and thereby a cycle time for creating a mass spectrum cannot be unduly extended. Thus, an upper limit of the open time-period of the entrance gate electrode 15 is restricted by the cycle time for creating a mass spectrum. Therefore, as long as the open time-period of the entrance gate electrode 15 corresponds to a typical cycle time for creating a mass spectrum, and the supply flow rate of a sample solution falls within a spraying capability of the nano-ESI nozzle 11, an amount of ions to be introduced into the ion guide 14 can be set to be less than the saturated ion amount in most cases.

A difference in function/effect between two cases: one case where a quadrupole rod-type ion guide is used as the ion holding section as in a mass spectrometry apparatus of the present invention; and the other case where an octopole rod-type ion guide is used as the ion holding section, will be described below.

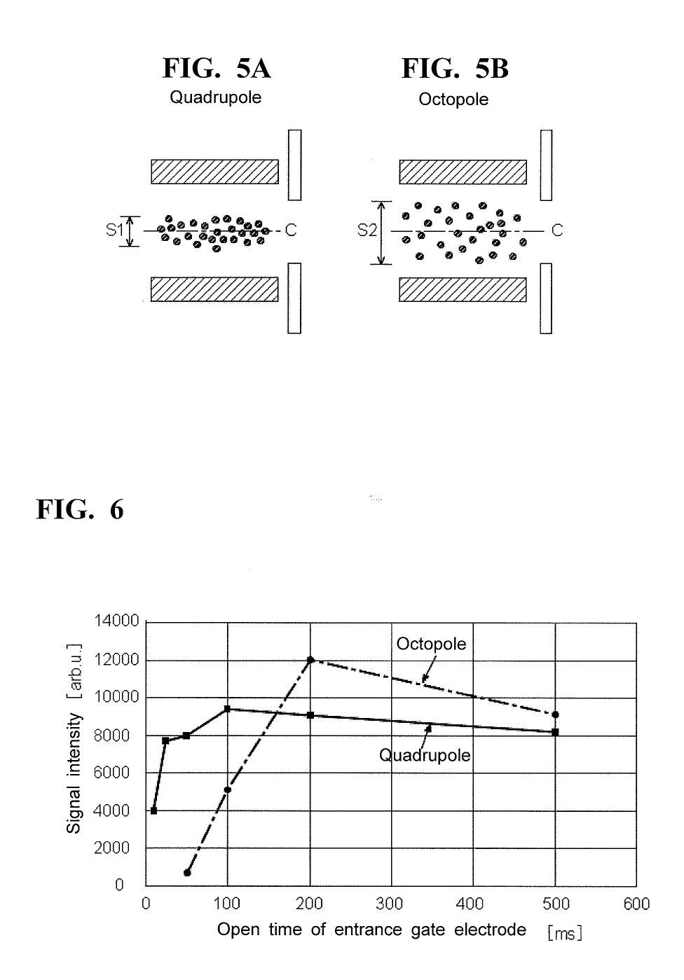

FIG. 4 is a graph showing a potential distribution to be formed in a radial direction of an inscribed circle in each of the quadrupole rod-type ion guide and the octopole rod-type ion guide, by a theoretical value, wherein a position 0 on the horizontal axis is a position on the ion optical axis C, and each of opposite ends of the horizontal axis is a position of an inner edge of a rod electrode (a position on a circumference of an inscribed circle of rod electrodes). FIGS. 5A and 5B conceptually illustrate a state of ions accumulated and held in an exit end of each of the quadrupole rod-type and octopole rod-type ion guides, wherein FIG. 5A is a schematic diagram showing the state in the quadrupole rod-type ion guide, and FIG. 5B is a schematic diagram showing the state in the octopole rod-type ion guide, wherein the same amount of ions are held in each of the quadrupole rod-type and octopole rod-type ion guides.

As seen in FIG. 4, a pseudopotential of a high-frequency electric field formed in the quadrupole rod-type ion guide is approximately proportional to a square of a distance r from a center of the inscribed circle. That is, the pseudopotential in this case is distributed in a shape close to a quadratic curve. In contract, a pseudopotential of a high-frequency electric field formed in the octopole rod-type ion guide is approximately proportional to an eighth power of the distance r. That is, the pseudopotential in this case is distributed in a shape close to a sextic curve.

Charged ions tend to move toward a position having a lower potential. In the octopole rod-type ion guide, a flat portion in a bottom of the pseudopotential curve not only lies around the ion optical axis C but also extends close to the inner edge of the rod electrode. Thus, the ions are likely to reside not only around the ion optical axis C but also in a wide space surrounding the ion optical axis C. Differently from the octopole rod-type ion guide, in the quadrupole rod-type ion guide, the potential is sharply increased from a vicinity of the ion optical axis C in opposite directions. Thus, the ions easily gather around the ion optical axis C without spreading outwardly.

That is, in the quadrupole rod-type ion guide, an ion-converging capability based on a high-frequency electric field is relatively high, and therefore ions reside around the ion optical axis C at a high density. Thus, if an absolute amount of ions is small, almost all the ions will be accumulated around the ion optical axis C, although the ion density inevitably has an upper limit because a repulsion force acts between ions charged with the same polarity. Consequently, as shown in FIG. 5A, ions reside in a narrow range (narrow space) about the ion optical axis C, indicated by S1.

In contrast, in the octopole rod-type ion guide, an ion-converging capability based on a high-frequency electric field is relatively low, and thereby a space allowing ions to reside therein is wider than that of the quadrupole rod-type ion guide. Thus, as shown in FIG. 5B, ions can reside in a wide range around the ion optical axis C, indicated by S2. The wide space allowing ions to reside therein provides an enhanced ion-accumulating capability to hold a larger amount of ions. On the other hand, if an absolute amount of ions is small, the ions will reside in the wide space, and thereby an amount of ions residing around the ion optical axis C will be reduced as compared with the quadrupole rod-type ion guide.

When the exit gate electrode 16 is opened, ions accumulated in the above manner are moved toward the ion inlet port of the ion trap 18 via the exit gate electrode 16. The ion trap 18 originally has a low ion-receiving capability, and thereby ions located away from the ion optical axis C are not trapped by the ion trap 10. Thus, if ions are accumulated around the ion optical axis C as shown in FIG. 5A, almost all the ions can be introduced into and trapped by the ion trap 10. However, if ions spreadingly reside away from the ion optical axis C as shown in FIG. 5B, only a small part of the ions residing around the ion optical axis C can be introduced into the ion trap 18, and the remaining ions will be wasted without being introduced into the ion trap 18. Consequently, in the octopole rod-type ion guide, a ratio of an amount of ions introduced into and trapped by the ion trap to a total amount of ions introduced into and accumulated in the ion guide, i.e., ion introduction efficiency, is lowered. Conversely, in the quadrupole rod-type ion guide, the ion introduction efficiency is relatively high, and therefore a larger amount of ions can be held in the ion trap and subjected to a mass spectrometric analysis.

The above description has been made on the assumption that an amount of ions to be introduced into the ion guide is less than the saturated ion amount in the ion guide. It is understood that the saturated ion amount varies depending on dimensions, such as a diameter and a radius of an inscribed circle, of the quadrupole rod-type ion guide and a high-frequency voltage to be applied to the ion guide, and comes under an influence of a surrounding temperature and a degree of vacuum. Therefore, it is difficult to accurately derive the saturated ion amount, based on a theoretical calculation. According to a result of simulation calculation carried out by the inventors in consideration of the ion-ion repulsion space-charge effect to check the number of ions introduced into the ion guide and behavior of the ions under a given conditions, when the number of ions is 10⁶, the ions are diverged without being held in the ion guide. Further, when the number of ions is 10⁵, a part of the ions is scattered along a direction of the ion optical axis although the remaining ions can be held in the ion trap, and, when the number of ions is 10⁴, the ions are adequately held in the ion guide. In view of this result, it can be assumed that the saturated ion amount is in the range of 10⁴ to 10⁵.

The above result can also be confirmed by a theoretical speculation on a relationship between a potential based on the ion-ion repulsion space-charge effect and a potential based on a high-frequency electric field.

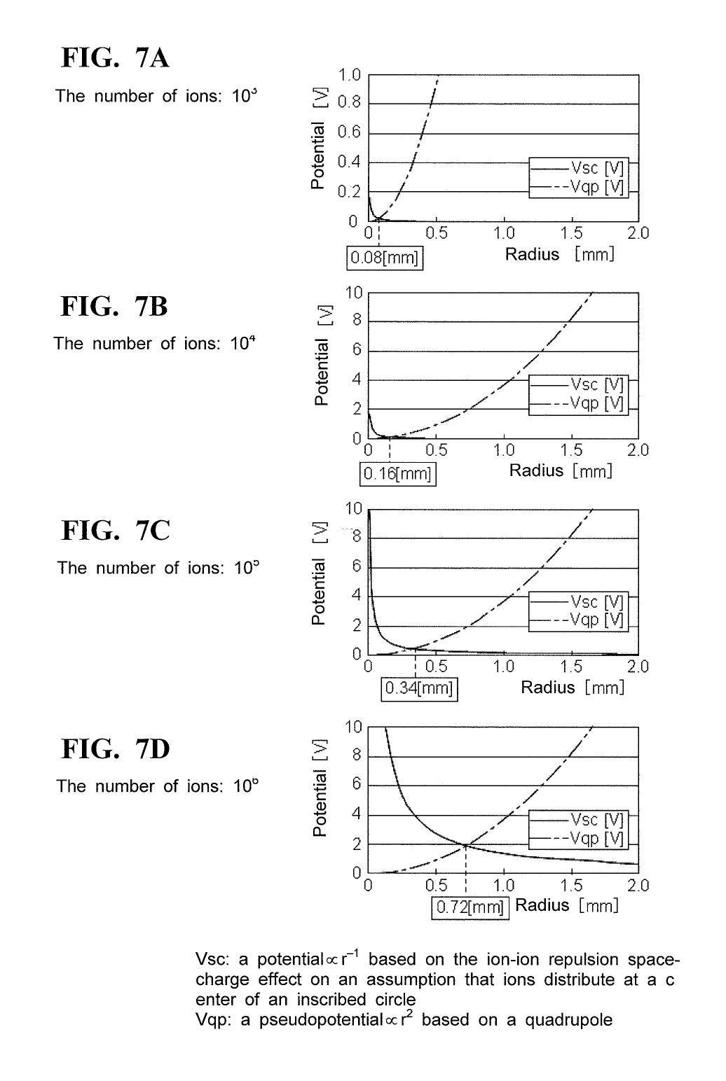

FIGS. 7A to 7D are graphs showing a relationship between a pseudopotential Vqp based on a high-frequency electric field and a potential Vsc based on the ion-ion repulsion space-charge effect, in a quadrupole rod-type ion guide, wherein the horizontal axis represents a position in a radial direction of an inscribed circle of the ion guide. In this quadrupole rod-type ion guide, a radius of the inscribed circle is set at 2 mm. The pseudopotential Vqp is distributed in the same curve as that illustrated in FIG. 4. The potential Vsc based on the ion-ion repulsion space-charge effect is a calculation result on a potential on an assumption that 10³, 10⁴, 10⁵ or 10⁶ ions are distributed around a center of the inscribed circle.

In a range where the potential Vsc based on the ion-ion repulsion space-charge effect is greater than the pseudopotential Vqp based on a high-frequency electric field, it can be considered that ions are diverged due to the ion-ion repulsion space-charge effect. Thus, ions can spread up to a radial position corresponding to an intersecting point between a curve of the potential Vsc and a curve of the pseudopotential Vqp. Moreover, in a region where the radial position is greater than 0.5 mm, a constraint force against ions becomes insufficient to cause divergence of many ions. In a region where the radial position is close to 0.5 mm even if it is equal to or less than 0.5 mm, ions are highly likely to escape in the direction of the ion optical axis C. In view of the above speculation, it can be considered that it is hard to stably hold ions under the condition that the number of ions is set at 10⁵, whereas it is possible to stably hold ions if the condition that the number of ions is set at 10⁴. Thus, under the assumed conditions in the above speculation, it is considered that the saturated ion amount is 10⁴ or a value slightly greater than 10⁴.

According to inventors' speculation, under analysis conditions in conventional commonly-used LC/MA apparatuses, ions are introduced into a quadrupole rod-type ion guide in an amount greater than a saturated ion amount in the ion guide. Consequently, a part of the introduced ions will be wasted without being held in the ion guide. In contrast, an octopole rod-type ion guide has a higher ion-accumulating capability, and a saturated ion amount therein is fairly greater than that in the quadrupole rod-type ion guide. Thus, the octopole rod-type ion guide can hold a larger part of ions introduced therein without wasting them. In this state, although ions held in the octopole rod-type ion guide spread over a wide range as shown in FIG. 5B, a density of the ions is increased to a level approximately equal to that in FIG. 5A, because a larger number of ions are introduced therein. Thus, ions flow out of the octopole rod-type ion guide when an exit gate electrode is opened, so that ions can be introduced into and trapped by an ion trap in a larger amount (as an absolute amount) greater than that in the quadrupole rod-type ion guide, although it is stochastically hard to introduce ions located away from an ion optical axis C, into the ion trap.

The following description will be made about an experimental test carried out to confirm the above speculation. In this test, a sample used was Na-TFA, and an ionization process was an ESI process. A peak intensity at a mass-to-charge ratio m/z=1246.7 was measured while changing an open time-period of an entrance gate electrode. A measurement result is shown in FIG. 6. In an open time-period of the entrance gate electrode, ions are successively supplied from an ion source in an approximately constant amount. Thus, the open time-period on the horizontal axis in FIG. 6 can be converted to an amount of ions introduced into an ion guide. In an octopole rod-type ion guide, a signal intensity is increased in proportion to an amount of introduced ions when the open time-period is set at a value less than 200 ms, and saturated when the open time-period is set at 200 ms or more. Thus, it can be considered that, an amount of ions introduced when the open time-period is set at 200 ms corresponds to a saturated ion amount in the octopole rod-type ion guide.

In a quadrupole rod-type ion guide, the signal intensity is saturated under a condition that the open time-period is set at about 20 to 30 ms, and a value of the signal intensity after the saturation is less than that in the octopole rod-type ion guide. The reason would be that the quadrupole rod-type ion guide is inferior in ion-accumulating capability to the octopole rod-type ion guide, and thereby can hold only a relatively small amount of ions. Thus, it can be said that, in a situation where a sufficient amount of ions are supplied from an ion source, an octopole rod-type ion guide can provide higher analysis sensitivity as compared with a quadrupole rod-type ion guide.

On the other hand, in a region where an open time-period is set at less than 20 to 30 ms and the signal intensity in the quadrupole rod-type ion guide is not saturated, the quadrupole rod-type ion guide clearly exhibits a higher signal intensity as compared with the octopole rod-type ion guide. The reason would be that, in the quadrupole rod-type ion guide, ions gather around an ion optical axis C in a small amount, based on its high ion-converging capability, and therefore it is possible to efficiently introduce the ions into an ion trap having a relatively low ion-receiving capability, as mentioned above. As is also evidenced by this test result, it can be concluded that, in cases where an amount of ions to be introduced into an ion guide, specifically ions are introduced into a quadrupole rod-type ion guide in an amount less than a saturated ion amount in the ion guide, a quadrupole rod-type ion guide provides higher detection sensitivity as compared with an octopole rod-type ion guide.

It is understood that the configuration for forming a DC electric filed having a potential gradient in a direction of an entrance to an exit of quadrupole rod-type ion guide is not limited to that described in the first embodiment, but various modifications and changes may be made therein, for example, as disclosed in the Patent Document 1.

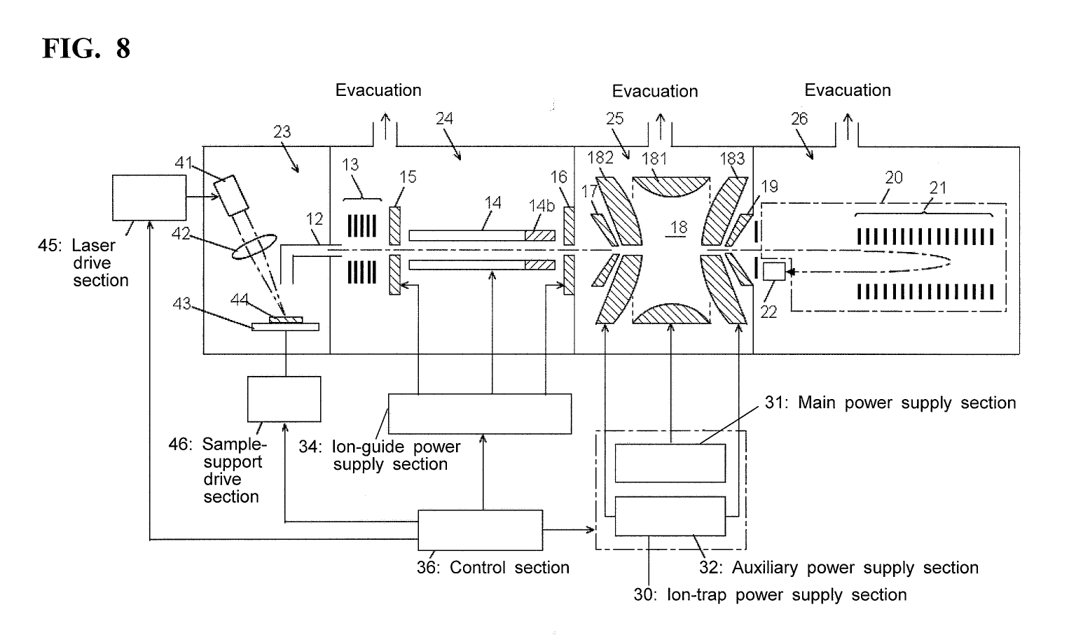

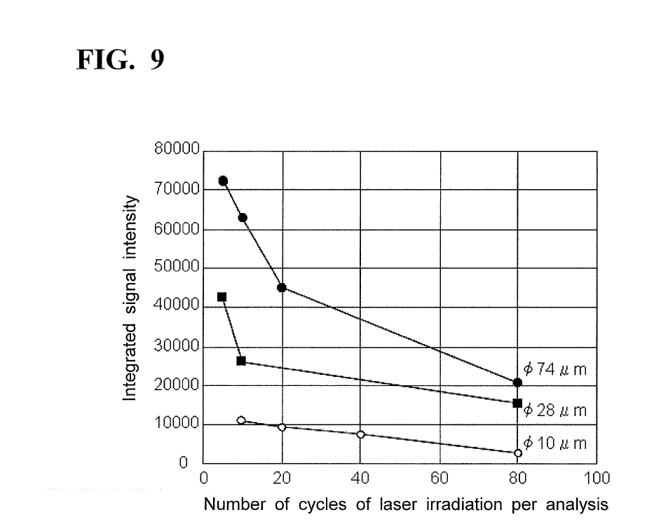

An IT-TOFMS apparatus according to a second embodiment of the present invention will be described below. FIG. 8 is a schematic block diagram showing the IT-TOFMS apparatus according to the second embodiment, wherein a same element or component as that in the first embodiment is defined by a common reference numeral or code, and its detailed description will be omitted.

The IT-TOFMS apparatus according to the second embodiment employs a matrix-assisted laser desorption/ionization (MALDI) ion source. The MALDI ion source is configured as follows. A pulsed laser beam emitted from a laser source 41 driven by a laser drive section 45 is focused by a focusing optical system 42 in such a manner as to allow a sample (a mixture of a matrix and a sample) 44 as a target substance placed on a sample support 43 to be irradiated with the focused laser beam. When the matrix in the sample 44 is vaporized by thermal energy of the laser beam, sample molecules are released together with the matrix and ionized. The generated ions are sent to a first intermediate vacuum chamber 24 through a capillary tube 12. Subsequently, the ions are held in a quadrupole rod-type ion guide 14, and accumulated in an ion trap 18, whereafter the ions are subjected to a mass spectrometric analysis, in the same manner as that in the first embodiment.

The sample support 43 is adapted to be two-dimensionally (in FIG. 8, horizontally and two-dimensionally) moved by a sample-support drive section 46, in such a manner as to change a position of the lased beam irradiation on the sample 44. For example, a biological tissue excised from a biological body may be used as the sample 44 to acquire a two-dimensional mass spectrometric image of a surface of the biological tissue. Further, an optical system or a mechanism capable of microscopically observing the sample 44 on the sample support 43 may be provided to allow a user to determine a range of mass spectrometric imaging, etc., through microscopic observation, before a mass spectrometric analysis.

The IT-TOFMS apparatus according to the second embodiment is designed to adjust an intensity of the laser beam irradiation on the sample 44 to control an amount of ions to be generated by one cycle of the laser beam irradiation. Further, in cases where ions generated by a plurality of cycles of pulsed-laser beam irradiation are collectively held in the quadrupole rod-type ion guide 14, the number of cycles of the laser beam irradiation can be reduced to control an amount of ions to be introduced into the ion guide 14. Thus, an amount of ions to be introduced into the ion guide 14 can be controlled to become less than a saturated ion amount, by appropriately setting at least either one of an intensity of the laser beam irradiation and the number of cycles of the laser beam irradiation, under a condition that an entrance gate electrode 15 is maintained in its open state.

In an MALDI ion source or other laser desorption/ionization (LDI) ion source, it is a common practice to collect ions generated by a plurality of cycles of irradiation with a laser beam to perform a mass spectrometric analysis, in the above manner, because an amount of ions to be generated by one cycle of the laser beam irradiation is small. In this case, given that a total number of cycles of the laser beam irradiation is fixed to a given value, a higher signal intensity can be obtained by repeating an analysis operation of generating ions by a certain number of cycles less than the total number and subjecting the ions to a mass spectrometric analysis, plural times, and then subjecting respective analysis results (respective signal intensities at a given mass-to-charge ratio m/z) obtained by the mass spectrometric analyses, to an integration processing.

With reference to FIG. 9, a test result on this technique will be described below. This test result was obtained by irradiating a sample of mouse cerebellum with a total number of cycles of irradiation with a laser beam in order to measure a signal intensity at a mass-to-charge ratio of 798.5. In FIG. 9, a value of integrated signal intensity at the laser irradiation cycle number (the number of cycles of the laser beam irradiation) “80” on the horizontal axis was obtained by performing an analysis operation of generating ions by 80 cycles of the laser beam irradiation, accumulating the generated ions in the ion guide 14, introducing the accumulated ions into the ion trap 18 to hold them in the ion trap 18, and simultaneously ejecting the ions from the ion trap 18 into a TOF mass analyzer 20 to perform a mass spectrometric analysis. In this case, the mass spectrometric analysis is performed only once, and an integration processing is not performed after the analysis operation. A value of integrated signal intensity at the laser irradiation cycle number “20” was obtained by repeating an analysis operation of generating ions by 20 cycles of the laser beam irradiation, accumulating the generated ions in the ion guide 14, introducing the accumulated ions into the ion trap 18 to hold them in the ion trap 18, and simultaneously ejecting the ions from the ion trap 18 into the TOF mass analyzer 20 to perform a mass spectrometric analysis, four times, and then subjecting respective signal intensities obtained by the four mass spectrometric analyses to an integration processing. That is, given that an amount of ions to be generated by one cycle of the laser beam irradiation is a constant value, it can be considered that an amount of ions to be introduced into the ion guide 14 in the latter analysis operation is reduced to one-fourth that in the former analysis operation.

As seen in FIG. 9, the technique of reducing the number of cycles of the laser beam irradiation per analysis operation and increasing the number of the analysis operations provides a higher signal intensity, in all laser beam spot sizes of 10 μm, 28 μm and 74 μm. That is, higher analysis sensitivity can be obtained by dividing ions into small groups, performing a mass spectrometric analysis for each of the small groups, and subjecting respective results of the mass spectrometric analyses to an integration processing. The reason would be that, even if an amount of ions is less than a saturated ion amount in the quadrupole rod-type ion guide 14, ions are more likely to reside in a space close to an ion optical axis C as an amount of ions accumulated in the ion guide 14 becomes smaller, and the ions are more efficiently introduced into the ion trap 18.

In cases where a TOF mass analyzer is used for a mass spectrometric analysis, it is necessary to take a certain time for the mass spectrometric analysis. Thus, the above technique involving an increase in the number of analysis operations is likely to have disadvantages in analysis time and throughput. Thus, it is preferable to change analysis conditions depending on an intended purpose of analysis and/or a type of sample (e.g., ionizability of a sample). Specifically, in cases where it is desirable to give greater importance to analysis time and throughput than analysis sensitivity, the number of cycles of the laser beam irradiation per analysis operation may be increased while reducing the number of analysis operations. In cases where it is desirable to give greater importance to analysis sensitivity than analysis time and throughput, the number of cycles of the laser beam irradiation per analysis operation may be reduced while increasing the number of analysis operations.

As seen in the results in FIGS. 6 and 9, analysis sensitivity is improved to about five times that in a conventional IT-TOFMS apparatus, by the technique employed in the present invention. For example, in mass spectrometric imaging, a signal intensity improved to five times can provide an image having significantly enhanced contrast. In this respect, the present invention has a significant advantageous effect.

In the above embodiments, the high-frequency voltage to be applied to the ion trap 10 is formed to have a rectangular waveform. Alternatively, the ion trap may be designed in a so-called analog-driven type ion trap using a high-frequency voltage having a sinusoidal waveform. In the aforementioned digital-driven type ion trap, the electric field-correcting electrode 17 is provided on the side of the outer surface of the entrance endcap electrode 182, and ions are introduced into the ion trap 18 from the outside thereof. That is, it is necessary to allow the ions to pass through both the opening of the electric field-correcting electrode 17 and the ion inlet port of the endcap electrode 182. Thus, the ion introduction condition is severer than that in the analog-driven type ion trap, and it is more critical to accumulate ions around the ion optical axis C in order to increase ion introduction efficiency. In this respect, the present invention is effective in a mass spectrometry apparatus using the digital-driven type ion trap.

One of the features of the quadrupole rod-type ion guide as compared with the octopole rod-type ion guide is that it has a high ion-mass selection function. Specifically, ions having a specific mass or falling within a specific mass range can be selected by applying a voltage formed by superimposing an appropriate DC voltage on a high-frequency voltage, to each of four rod electrodes, as in a quadrupole mass filter. Thus, detection sensitivity can be enhanced by setting a mass-to-charge ratio m/z of ions to be held in the quadrupole rod-type ion guide 14, in a given limited range to hold only a specific type of ions in a large amount. This technique is effective to eliminate low-mass ions originating from foreign substances to reduce the ion-ion repulsion space-charge effect in an ion guide, such as an MALDI ion trap, and increase sensitivity to ions to be observed.

The above embodiments have been shown and described by way of example. It is to be understood that various changes and modifications will be apparent to those skilled in the art. Therefore, unless otherwise such changes and modifications depart from the scope of the present invention hereinafter defined, they should be construed as being included therein.

What is claimed is:

1. A mass spectrometry method for use with a mass spectrometry apparatus which includes a) an ion source operable to supply ions originating from a sample, b) a three-dimensional quadrupole ion trap operable to temporarily accumulate ions introduced thereinto from an outside thereof, and then perform a mass spectrometric analysis by itself, or eject the accumulated ions therefrom to perform a mass spectrometric analysis in an outside thereof, c) a quadrupole rod-type ion holding section disposed between said ion source and said three-dimensional quadrupole ion trap, and operable to accumulate and hold ions in an exit end thereof according to a high-frequency electric field for confining ions and a DC electric field having a potential gradient in a direction from an entrance to an exit thereof, d) an entrance gate electrode disposed between said ion source and said ion holding section, and e) an exit gate electrode disposed between said ion holding section and said three-dimensional quadrupole ion trap, said mass spectrometry method comprising:
introducing ions from said ion source into said ion holding section through said entrance gate electrode, in an amount less than a saturated ion amount which is a maximum capacity of said ion holding section to hold ions therein, to allow said ion holding section to hold ions therein; and
opening said exit gate electrode to simultaneously introduce the ions accumulated in said exit end of said ion holding section, into said three-dimensional quadrupole ion trap, to allow said three-dimensional quadrupole ion trap to accumulate ions therein.

2. A mass spectrometry apparatus designed to introduce ions into a three-dimensional quadrupole ion trap from an outside thereof to accumulate the introduced ions in said three-dimensional quadrupole ion trap, and then perform a mass spectrometric analysis, said mass spectrometry apparatus comprising:
a) an ion source operable to supply ions originating from a sample;
b) a quadrupole rod-type ion holding section disposed between said ion source and said three-dimensional quadrupole ion trap, and operable to accumulate and hold ions in an exit end thereof according to a high-frequency electric field for confining ions and a DC electric field having a potential gradient in a direction from an entrance to an exit thereof;
c) an entrance gate electrode disposed between said ion source and said ion holding section;
d) an exit gate electrode disposed between said ion holding section and said three-dimensional quadrupole ion trap; and
e) control means operable to control said ion source or said entrance gate electrode to introduce ions into said ion holding section in an amount less than a saturated ion amount which is a maximum capacity of said ion holding section to hold ions therein, to allow said ion holding section to hold ions therein, and then control said exit gate electrode to simultaneously introduce the ions accumulated in said exit end of said ion holding section, into said three-dimensional quadrupole ion trap.

3. The mass spectrometry apparatus as defined in claim 2, wherein:
said ion source is operable to ionize a sample or a target substance containing components of said sample, by irradiation with a laser beam; and
said control means is operable to reduce the number of cycles of said laser beam irradiation or lower an intensity of said laser beam irradiation per cycle, in said ion source during said operation of allowing said ion holding section to hold therein ions to be introduced from said ion holding section into said three-dimensional quadrupole ion trap, in such a manner that an amount of ions to be held in said ion holding section becomes less than said saturated ion amount.

4. The mass spectrometry apparatus as defined in claim 3, which is designed to two-dimensionally scan a position of said laser beam irradiation on said sample or said target substance to acquire two-dimensional mass distribution information.

5. The mass spectrometry apparatus as defined in claim 2, wherein:
said ion source is an atmospheric pressure ion source operable to spray a sample solution containing components of a sample into an atmosphere at an approximately atmospheric pressure to ionize said sample components; and
said control means is operable to set at least either one of an ion generation condition in said atmospheric pressure ion source, and an open time-period of said entrance gate electrode, in such a manner that an amount of ions to be held in said ion holding section becomes less than said saturated ion amount.

6. The mass spectrometry apparatus as defined in claim 5, wherein said ion source is a nano-electrospray ion source.

7. The mass spectrometry apparatus as defined in claim 2, wherein said three-dimensional quadrupole ion trap includes a pair of entrance and exit endcap electrodes, a ring electrode, and an electric field-correcting electrode disposed on the side of an outer opening of an ion inlet port formed in said entrance endcap electrode, wherein a voltage to be applied to said entrance and exit endcap electrodes has a rectangular waveform.

8. The mass spectrometry apparatus as defined in claim 2, which is designed to adjust a DC voltage and a high-frequency voltage to be applied to each of four rod electrodes of said ion holding section, to perform mass selection of ions to be held in said mass holding section.

9. A mass spectrometry method for use with a mass spectrometry apparatus which includes a) an ion source operable to irradiate a sample or a target substance containing components of said sample with a laser beam to ionize said sample components, b) a three-dimensional quadrupole ion trap operable to temporarily accumulate ions introduced thereinto from an outside thereof, and then perform a mass spectrometric analysis by itself, or eject the accumulated ions therefrom to perform a mass spectrometric analysis in an outside thereof, c) a quadrupole rod-type ion holding section disposed between said ion source and said three-dimensional quadrupole ion trap, and operable to accumulate and hold ions in an exit end thereof according to a high-frequency electric field for confining ions and a DC electric field having a potential gradient in a direction from an entrance to an exit thereof, d) an entrance gate electrode disposed between said ion source and said ion holding section, and e) an exit gate electrode disposed between said ion holding section and said three-dimensional quadrupole ion trap, said mass spectrometry method comprising:
introducing ions generated in said ion source by a plurality of cycles of said laser beam irradiation, into said ion holding section through said entrance gate electrode, to allow said ion holding section to hold ions therein;
opening said exit gate electrode to simultaneously introduce the ions accumulated in said exit end of said ion holding section, into said three-dimensional quadrupole ion trap, to allow said three-dimensional quadrupole ion trap to accumulate ions therein; and
performing a mass spectrometric analysis for said accumulated ions by:
dividing the plurality of cycles of said laser beam irradiation in said ion source during said operation of allowing said ion holding section to hold ions therein, into a plurality of groups;
cyclically repeating an analysis operation of holding ions generated by said divided group of cycles of said laser beam irradiation, in said ion holding section, and introducing said ions into said three-dimensional quadrupole ion trap to perform a mass spectrometric analysis, given times equal to a total number of said divided groups; and
subjecting respective results of said mass spectrometric analyses to an integration processing to obtain a mass spectrometric result for a same region on said sample or said target substance.

10. The mass spectrometry apparatus as defined in claim 3, wherein said three-dimensional quadrupole ion trap includes a pair of entrance and exit endcap electrodes, a ring electrode, and an electric field-correcting electrode disposed on the side of an outer opening of an ion inlet port formed in said entrance endcap electrode, wherein a voltage to be applied to said entrance and exit endcap electrodes has a rectangular waveform.

11. The mass spectrometry apparatus as defined in claim 3, which is designed to adjust a DC voltage and a high-frequency voltage to be applied to each of four rod electrodes of said ion holding section, to perform mass selection of ions to be held in said mass holding section.

12. The mass spectrometry apparatus as defined in claim 4, wherein said three-dimensional quadrupole ion trap includes a pair of entrance and exit endcap electrodes, a ring electrode, and an electric field-correcting electrode disposed on the side of an outer opening of an ion inlet port formed in said entrance endcap electrode, wherein a voltage to be applied to said entrance and exit endcap electrodes has a rectangular waveform.

13. The mass spectrometry apparatus as defined in claim 4, which is designed to adjust a DC voltage and a high-frequency voltage to be applied to each of four rod electrodes of said ion holding section, to perform mass selection of ions to be held in said mass holding section.

14. The mass spectrometry apparatus as defined in claim 5, wherein said three-dimensional quadrupole ion trap includes a pair of entrance and exit endcap electrodes, a ring electrode, and an electric field-correcting electrode disposed on the side of an outer opening of an ion inlet port formed in said entrance endcap electrode, wherein a voltage to be applied to said entrance and exit endcap electrodes has a rectangular waveform.

15. The mass spectrometry apparatus as defined in claim 5, which is designed to adjust a DC voltage and a high-frequency voltage to be applied to each of four rod electrodes of said ion holding section, to perform mass selection of ions to be held in said mass holding section.

16. The mass spectrometry apparatus as defined in claim 6, wherein said three-dimensional quadrupole ion trap includes a pair of entrance and exit endcap electrodes, a ring electrode, and an electric field-correcting electrode disposed on the side of an outer opening of an ion inlet port formed in said entrance endcap electrode, wherein a voltage to be applied to said entrance and exit endcap electrodes has a rectangular waveform.

17. The mass spectrometry apparatus as defined in claim 6, which is designed to adjust a DC voltage and a high-frequency voltage to be applied to each of four rod electrodes of said ion holding section, to perform mass selection of ions to be held in said mass holding section.

18. The mass spectrometry apparatus as defined in claim 7, which is designed to adjust a DC voltage and a high-frequency voltage to be applied to each of four rod electrodes of said ion holding section, to perform mass selection of ions to be held in said mass holding section.
